(19) United States
(12) Patent Application Publication
(10) Pub. No.: US 2022/0166050 A1
(43) Pub. Date: May 26, 2022

(54) RECHARGEABLE BATTERY

(71) Applicant: SAMSUNG SDI CO., LTD., Yongin-si (KR)

(72) Inventors: Joonhong PARK, Yongin-si (KR); Hee-Myeong SON, Yongin-si (KR)

(21) Appl. No.: 17/531,185

(22) Filed: Nov. 19, 2021

(30) Foreign Application Priority Data
Nov. 25, 2020 (KR) 10-2020-0160188

(51) Int. Cl. H01M 10/04; H01M 50/109; H01M 50/153; H01M 50/533

(52) U.S. Cl. CPC H01M 10/0427; H01M 50/109; H01M 10/0431; H01M 50/533; H01M 50/153

(57) ABSTRACT

A rechargeable battery includes: an electrode assembly including a first electrode tab and a second electrode tab; a case accommodating the electrode assembly and electrically connected to the first electrode tab; a cap assembly including a cap plate coupled to an opening of the case, and a terminal plate coupled to the cap plate in an insulating state and electrically connected to the second electrode tab; and a conductive double-sided adhesive member applied to at least one of a first connection between the first electrode tab and the case and a second connection between the second electrode tab and the terminal plate.

### CROSS-REFERENCE TO RELATED APPLICATION

This application claims priority to and the benefit of Korean Patent Application No. 10-2020-0160188, filed on Nov. 25, 2020 in the Korean Intellectual Property Office, the entire content of which is incorporated herein by reference.

### BACKGROUND

### 1. Field

Aspects of embodiments of the present invention relate to a rechargeable battery.

### 2. Description of the Related Art

Unlike a primary battery that is incapable of being recharged, a rechargeable battery can be repeatedly charged and discharged. A low-capacity rechargeable battery has been used for small electronic devices, such as a mobile phone, a laptop computer, and a camcorder, and a large-capacity battery has been widely used as a power source for driving a motor of a hybrid vehicle, for example.

A representative rechargeable battery includes any of a nickel-cadmium (Ni—Cd) battery, a nickel-hydrogen (Ni-MH) battery, a lithium (Li) battery, and a lithium ion (Li-ion) rechargeable battery. Particularly, the lithium ion secondary battery has a higher operation voltage than the nickel-cadmium battery or the nickel-hydrogen battery that is mainly used as a portable electric equipment power source by about three times. Also, the lithium ion secondary battery is widely used in an aspect that energy density per unit weight is high.

In particular, as a demand for wearable devices, such as headphones, earphones, smartwatches, and body-mounted medical devices which use Bluetooth, has increased, the need for a rechargeable battery of which energy density is high and is ultra-small is increasing.

The ultra-small rechargeable battery has important tasks of securing required electrical capacity within a limited size, implementing an efficient structure while improving an effective low weight, and improving structural stability.

The above information disclosed in this Background section is provided for enhancement of understanding of the background of the invention, and, therefore, it may contain information that does not form the prior art that is already known in this country to a person of ordinary skill in the art.

### SUMMARY

According to an aspect of embodiments of the present invention, an ultra-small rechargeable battery is provided.

According to an aspect of embodiments of the present invention, a rechargeable battery that has a simplified process of connecting an electrode tab of an electrode assembly to a terminal plate or a case is provided. According to another aspect of embodiments of the present invention, a rechargeable battery that has a simplified process of connecting an external tab of the rechargeable battery to a set is provided.

According to one or more embodiments of the present invention, a rechargeable battery includes: an electrode assembly including a first electrode tab and a second electrode tab; a case accommodating the electrode assembly and electrically connected to the first electrode tab; a cap assembly including a cap plate coupled to an opening of the case, and a terminal plate coupled to the cap plate in an insulating state and electrically connected to the second electrode tab; and a conductive double-sided adhesive member applied to at least one of a first connection between the first electrode tab and the case and a second connection between the second electrode tab and the terminal plate.

The conductive double-sided adhesive member may include a conductive double-sided tape.

The conductive double-sided tape may include a conductive mesh part having a mesh structure with conductivity, and a rubber adhesive filled around the conductive mesh part to form the first connection and the second connection.

The conductive double-sided adhesive member may include an anisotropic conductive film.

The first connection may electrically and mechanically connect with a first conductive double-sided tape of the conductive double-sided adhesive member that is arranged between a lower surface of the first electrode tab and an inner surface of the case facing each other.

The second connection may electrically and mechanically connect with a second conductive double-sided tape of the conductive double-sided adhesive member that is arranged between an upper surface of the second electrode tab and a lower surface of the terminal plate facing each other

The terminal plate may include a flange part on an outside of the cap plate, and electrically insulated and attached to an outer surface of the cap plate with a thermal fusion member therebetween, and a tab connection part protruded from a center of the flange part to an inside and protruded toward the electrode assembly through a through hole of the thermal fusion member and a terminal hole of the cap plate, and the second conductive double-sided tape may be electrically and mechanically connected between the second electrode tab and an inner surface of the tab connection part.

The terminal plate may include a flange part on an inside of the cap plate and electrically insulatedly attached to an inner surface of the cap plate with a thermal fusion member therebetween, and a protruded terminal protruded from a center of the flange part to an outside and passing through a through hole of the thermal fusion member and a terminal hole of the cap plate, and the second conductive double-sided tape may be mechanically and electrically connected between the second electrode tab and an inner surface of the flange part.

The terminal plate may include a flange part on an outside of the cap plate, and electrically insulated and attached to an outer surface of the cap plate with a thermal fusion member therebetween, and a tab connection part protruded from a center of the flange part to an inside of the flange part and protruded toward the electrode assembly through a through hole of the thermal fusion member and a terminal hole of the cap plate, and, in the third connection connecting the terminal plate to a set, a conductive double-sided adhesive member of the third connection is connected between a first external tab connected to an outer surface of the flange part and the set.

In a fourth connection that connects the case to the set, a conductive double-sided adhesive member of the fourth connection may be connected between a second external tab connected to an outer surface of the case and the set.

The terminal plate may include a flange part on an inside of the cap plate and electrically insulated and attached to an inner surface of the cap plate with a thermal fusion member therebetween, and a protruded terminal protruded from a center of the flange part to an outside and passing through a through hole of the thermal fusion member and a terminal hole of the cap plate, and, in a third connection connecting the terminal plate to a set, a conductive double-sided adhesive member of the third connection may be connected between a first external tab connected to an outer surface of the protruded terminal and the set.

As such, a rechargeable battery according to one or more embodiments of the present invention applies the conductive double-sided adhesive member to at least one of the first connection between the first electrode tab and the case and the second connection between the second electrode tab and the terminal plate, such that a process of connecting the first and second electrode tabs to the terminal plate or the case may be simplified.

In addition, a rechargeable battery according to one or more embodiments applies the conductive double-sided adhesive member to the connection between the external tab of the rechargeable battery and a set, such that a process of connecting the external tab to the set may be simplified.

### BRIEF DESCRIPTION OF THE DRAWINGS

FIG. 1 is a perspective view showing a rechargeable battery according to an embodiment of the present invention.

FIG. 2 is an exploded perspective view of the rechargeable battery of FIG. 1.

FIG. 3 is a cross-sectional view taken along the line III-III of FIG. 1.

FIG. 4 is an enlarged cross-sectional view of a part electrically and mechanically connecting a second electrode tab and a terminal plate with a second conductive double-sided tape applied to FIG. 2 and FIG. 3.

FIG. 5 is a perspective view showing a rechargeable battery according to an embodiment of the present invention.

FIG. 6 is an exploded perspective view of the rechargeable battery of FIG. 5.

FIG. 7 is a cross-sectional view taken along the line VII-VII of FIG. 5.

FIG. 8 is a cross-sectional view illustrating electrical connection of an external tab and a set of a rechargeable battery according to an embodiment.

FIG. 9 is a cross-sectional view illustrating electrical connection of an external tab and a set of a rechargeable battery according to an embodiment.

### DESCRIPTION OF REFERENCE SYMBOLS

| | |
|---|---|
| 10: electrode assembly | 11: first electrode |
| 12: second electrode | 13: separator |
| 20: case | 21: opening |
| 30, 60: cap assembly | 31: cap plate |
| 33, 63: terminal plate | 34: thermal fusion member |
| 40: conductive double-sided adhesive member | |
| 41: first conductive double-sided tape | |
| 42: second conductive double-sided tape | |
| 43, 243: third conductive double-sided tape | |
| 44: fourth conductive double-sided tape | |
| 51: first electrode tab | 52: second electrode tab |
| 53, 253: first external tab | 54: second external tab |
| 61, 62: insulating member | |
| 100, 200: rechargeable battery | 101: first end (lower cross-section) |
| 102: second end (upper cross-section) | 311: terminal hole |
| 331, 631: flange part | 332: protruded terminal |
| 341: through hole | 421: conductive mesh part |
| 422: rubber adhesive | 611, 622: through hole |
| 621: step | 632: tab connection part |
| D: battery diameter | H: height |
| S: set | |

### DETAILED DESCRIPTION

The present invention will be described more fully herein with reference to the accompanying drawings, in which some embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

In addition, unless explicitly described to the contrary, it is to be understood that terms such as “comprises,” “includes,” or “have” used in the present specification specify the presence of stated features, numerals, steps, operations, components, parts, or a combination thereof, but do not preclude the presence or addition of one or more other features, numerals, steps, operations, components, parts, or a combination thereof.

Also, in this specification, it is to be understood that when one component is referred to as being “connected” or “coupled” to another component, it may be connected or coupled directly to the other component or connected or coupled to another component with one or more other components intervening therebetween.

Singular forms are to include plural forms unless the context clearly indicates otherwise.

It is to be understood that, although the terms “first,” “second,” etc. may be used herein to describe various elements, these elements should not be limited by these terms. These terms are used to distinguish one element from another. For example, a first element could be termed a “second” element, and, similarly, a second element could be termed a “first” element, without departing from the scope of example embodiments of the inventive concept. The terms of a singular form may include plural forms unless the context clearly indicates otherwise.

In addition, terms such as “below,” “lower,” “above,” “upper,” and the like are used to describe the relationship of the configurations shown in the drawings. However, the terms are used as a relative concept and are described with reference to the direction indicated in the drawings.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

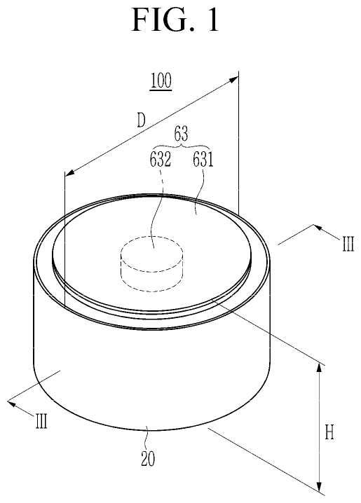

A rechargeable battery according to an embodiment of the present invention, which is an ultra-compact battery, may be a coin cell or a button cell. Here, the coin cell or the button cell is a thin coin-type or button-type cell, and refers to a battery having a ratio (H/D) of a height (H) to a diameter (D) of 1 or less (referring to FIG. 1).

Since the coin cell or the button cell is mainly cylindrical, a horizontal cross-section may be circular, but the present invention is not limited thereto, and a horizontal cross-section may be oval or polygonal. In this case, a diameter is determined as a maximum distance of a housing (or a case) exterior circumference based on the horizontal direction of the battery, and a height is determined as a maximum distance (a distance from a flat bottom to a flat top cross-section) based on the vertical direction of the battery.

However, the present invention is not limited to the coin cell or the button cell that is an example of the present invention, and a battery of the present invention may be a cylindrical-type or pin-type battery. Herein, a case in which a rechargeable battery according to an embodiment of the present invention is a coin cell or a button cell will be described as an example in further detail.

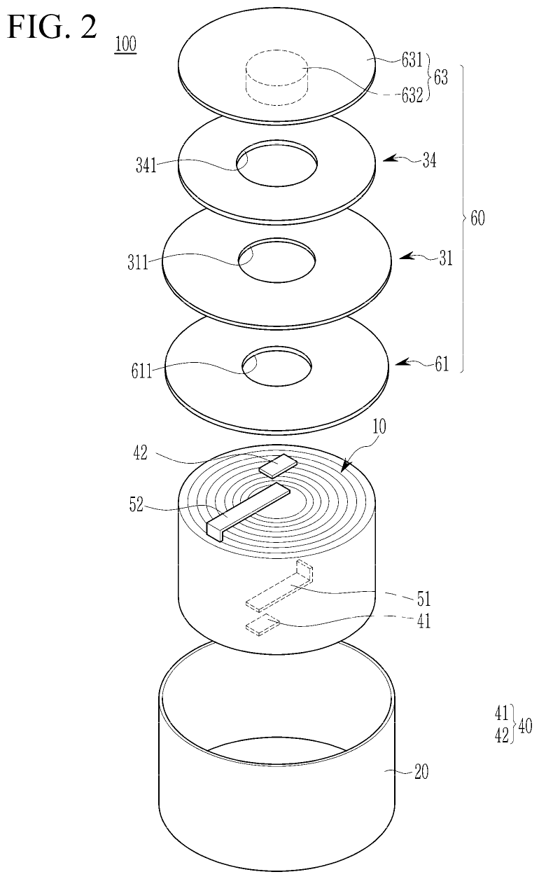

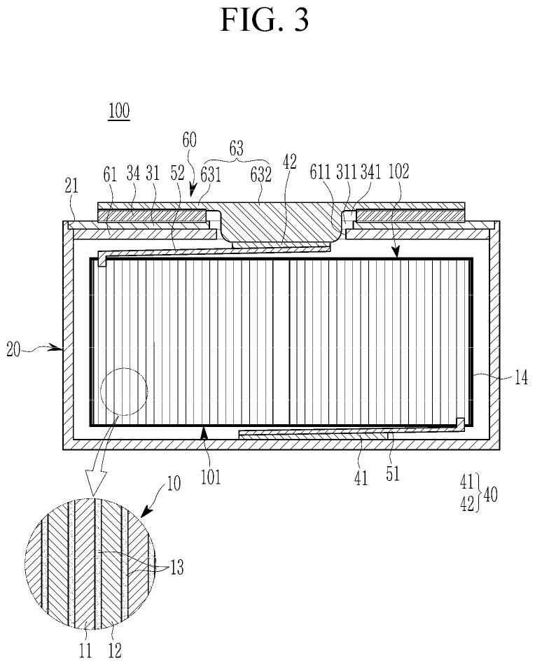

FIG. 1 is a perspective view showing a rechargeable battery according to an embodiment of the present invention; FIG. 2 is an exploded perspective view of the rechargeable battery of FIG. 1; and FIG. 3 is a cross-sectional view taken along the line III-III of FIG. 1. Referring to FIG. 1 to FIG. 3, a rechargeable battery 100 according to an embodiment includes an electrode assembly 10, a case 20, a cap assembly 60, and a conductive double-sided adhesive member 40.

The cap assembly 60 includes a cap plate 31 and a terminal plate 63 that are coupled together. As an example, the cap plate 31 and the terminal plate 63 are heat-sealed by a thermal fusion member 34 that is disposed between them.

The thermal fusion member 34 acts as a mediator for bonding the cap plate 31 and the terminal plate 63 to each other. For example, the thermal fusion member 34 may be formed of an electrically insulating material, such as a polymer, and may be melted using a laser or the like and fused to the cap plate 31 and the terminal plate 63.

According to an embodiment, a stable sealing and bonding structure may be formed while effectively insulating between the terminal plate 63 and the cap plate 31 without adding a separate insulating configuration by combining the terminal plate 63 to the cap plate 31 with the thermal fusion member 34.

The electrode assembly 10 includes a first electrode 11, for example, a negative electrode, and a second electrode 12, for example, a positive electrode, provided on respective surfaces of a separator 13, which is an electrically insulating material, and, in an embodiment, is formed by winding the first electrode 11, the separator 13, and the second electrode 12. Accordingly, the electrode assembly 10 may be formed as a jelly-roll type. Although not shown separately, in an embodiment, the electrode assembly may be formed as a stack type.

The electrode assembly 10 is configured to charge and discharge a current, and, in the electrode assembly 10, the wound axis may be arranged parallel to a height direction of the case 20 (an up and down direction in FIG. 1 to FIG. 3).

In an embodiment, a first end (a lower cross-section of the electrode assembly) 101 and a second end (an upper cross-section of the electrode assembly) 102 of the electrode assembly 10 may be flat and parallel to each other. In an embodiment, the electrode assembly 10 is not provided with a center pin, but may be provided with a center pin (not shown) at a position of the wound axis.

The case 20 accommodates the electrode assembly 10 while facing the first end 101 of the electrode assembly 10 with a bottom inner surface. In an embodiment, the electrode assembly 10 is coated with an insulating sheet 14 on the first and second ends 101 and 102 and sides of the electrode assembly 10 and is embedded with an electrolyte solution in the case 20. As an example, the case 20 is formed having a cylinder shape accommodating the electrode assembly 10 of a jelly-roll type, and the cap assembly 60 closes and seals an opening 21 of the cylindrical case 20.

The electrode assembly 10 includes a first electrode tab 51 connected to the first electrode 11 and a second electrode tab 52 connected to the second electrode 12, and draws out the first and second electrodes 11 and 12 at the first and second ends 101 and 102, respectively.

In a state in which the electrode assembly 10 is accommodated in the case 20, the first electrode tab 51 is electrically and mechanically connected (herein, a first connection) to the bottom inner surface of the case 20, and the second electrode tab 52 is electrically and mechanically connected (herein, a second connection) to an inner surface of the terminal plate 63 of the cap assembly 60.

The cap plate 31 of the cap assembly 60 is coupled to the case 20 while facing the second end 102 of the electrode assembly 10 to cover the opening 21. In an embodiment, the terminal plate 63 is connected to the second electrode tab 52 in a state in which the terminal plate 63 is coupled to the cap plate 31 with the thermal fusion member 34.

The first connection connects the first electrode tab 51 and the case 20 to each other through a conductive double-sided adhesive member 40. The second connection connects the second electrode tab 52 and the terminal plate 63 to each other through a conductive double-sided adhesive member 40.

In an embodiment, the conductive double-sided adhesive member 40 may be formed of a conductive double-sided tape or an anisotropic conductive film (ACF), which facilitates the process of the first and second connections. For convenience of explanation, the conductive double-sided tape is described as an example.

Herein, a case in which the first electrode 11 and the second electrode 12 are the negative electrode and the positive electrode, respectively, is described as an example, but the present invention is not limited thereto, and the first electrode 11 and the second electrode 12 may be the positive electrode and the negative electrode, respectively.

The first electrode (the negative electrode) 11 is formed in a long extending strip shape, and includes a negative electrode coated portion that is a region in which a negative electrode active material layer is coated to a current collector of a metal foil (for example, a Cu foil) and a negative electrode uncoated portion that is a region in which an active material is not coated. The negative electrode uncoated portion may be disposed at an end portion in a length direction of the negative electrode.

The second electrode (the positive electrode) 12 is formed in a long extending strip shape, and includes a positive electrode coated portion that is a region in which a positive electrode active material layer is coated to a current collector of a metal foil (for example, an Al foil) and a positive electrode uncoated portion that is a region in which an active material is not coated. The positive electrode uncoated portion may be disposed at an end portion in a length direction of the positive electrode.

The case 20 allows the electrode assembly 10 to be inserted into the opening 21 formed at a side thereof, and has a space for accommodating the electrode assembly 10 and an electrolyte therein. For example, the case 20 may be formed in a cylindrical shape having a height H that is less than a diameter D thereof, and may have a circular opening 21 such that the cylindrical electrode assembly 10 corresponding to an inner space thereof may be inserted.

In an embodiment, the terminal plate 63 of the cap assembly 60 includes a flange part 631 and a tab connection part 632. The flange part 631 is disposed to the outside of the cap plate 31 and is electrically insulated and attached to an outer surface of the cap plate 31 by interposing the thermal fusion member 34 therebetween.

In the terminal plate 63, the tab connection part 632 is protruded from a center of the flange part 631 to the inside, and passes through a through hole 341 of the thermal fusion member 34 and a terminal hole 311 of the cap plate 31 to be protruded toward the electrode assembly 10, and the second electrode tab 52 is electrically and mechanically connected to an inner surface of the tab connection part 632.

In an embodiment, the first connection electrically and mechanically connects the case 20 and the first electrode tab 51 with a first conductive double-sided tape 41 interposed between a lower surface of the first electrode tab 51 and an inner surface of the case 20 facing each other. The first conductive double-sided tape 41 facilitates the process of the first connection as simple and convenient, and improves (or reduces) deterioration of electrical characteristics due to poor welding.

The second connection electrically and mechanically connects the second electrode tab 52 and the terminal plate 63 with a second conductive double-sided tape 42 interposed between an upper surface of the second electrode tab 52 and a lower surface of the terminal plate 63 facing each other. That is, the second connection is made of a second conductive double-sided tape 42 interposed between the upper surface of the second electrode tab 52 and a lower surface of the tab connection part 632 facing each other. The second conductive double-sided tape 42 facilitates the process of the second connection as simple and convenient, and improves (or reduces) deterioration of electrical characteristics due to poor welding.

The first and second connections using the first and second conductive double-sided tapes 41 and 42 prevent or substantially prevent a metal welding foreign substance and heat that may occur during laser welding, ultrasonic welding, or resistance welding, thus eliminating a safety risk inside the battery. The first and second connections prevent or substantially prevent a deterioration of battery characteristics due to poor welding according to a condition state of the case 20 and the cap assembly 60 during the welding process. In an embodiment, the first and second connections are possible with a degree of supplying the first and second conductive double-sided tapes 41 and 42 through feeders and using an attachment jig, such that a simpler facility is required compared to an existing welding facility.

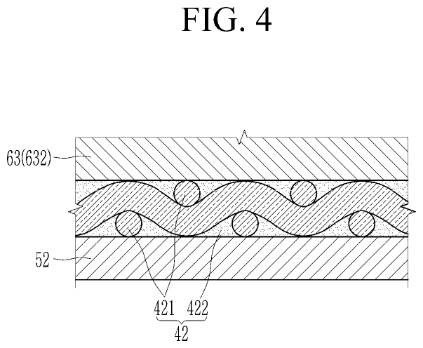

FIG. 4 is an enlarged cross-sectional view of a part for an electrical and mechanical connection between a second electrode tab and a terminal plate with a second conductive double-sided tape applied to FIG. 2 and FIG. 3. In an embodiment, the first and second connections form the same configuration, and the second connection is described with reference to FIG. 4 for convenience of explanation.

As an example, the second conductive double-sided tape 42 includes a conductive mesh part 421 having conductivity and formed into a mesh structure, and a rubber adhesive 422 filled around the conductive mesh part 421 to form the second connection. In an embodiment, the rubber adhesive 422 does not react with the electrolyte solution, and the second connection may be maintained continuously.

In an embodiment, an insulating member 61 is provided between the second electrode tab 52 and the cap plate 31. As an example, the insulating member 61 is disposed on an upper side of the second electrode tab 52 and is attached to an inner surface of the cap plate 31. The insulating member 61 may form an electrically insulating structure between the cap plate 31 and the second electrode tab 52 and between the cap plate 31 and the electrode assembly 10.

As an example, the insulating member 61 has a through hole 611 corresponding to the terminal hole 311 of the cap plate 31. Therefore, the tab connection part 632 is protruded from the center to the inside of the flange part 631 and passes through the terminal hole 311 of the cap plate 31 and the through hole 611 of the insulating member 61 to be protruded toward the electrode assembly 10, and the second electrode tab 52 is electrically and mechanically connected to the inner surface of the tab connection part 632 with the second conductive double-sided tape 42 interposed therebetween.

Referring to FIG. 1, in the rechargeable battery 100 according to an embodiment, in a state of closing and sealing the opening 21 of the case 20 with the cap assembly 60, the height H is set as the distance between outer planes of the case 20 and the flange part 631, and the battery diameter D is set with the exterior circumference of the case 20. In an embodiment, the ratio of the height H to the battery diameter D is 1 or less (H/D≤1). Therefore, the rechargeable battery 100 according to an embodiment may form a thin coin or button type as a coin-type battery or a button-type battery.

Herein, another embodiment of the present invention is described. In describing the present embodiment, the same configurations as the previous embodiment may be omitted, and different configurations are mainly described.

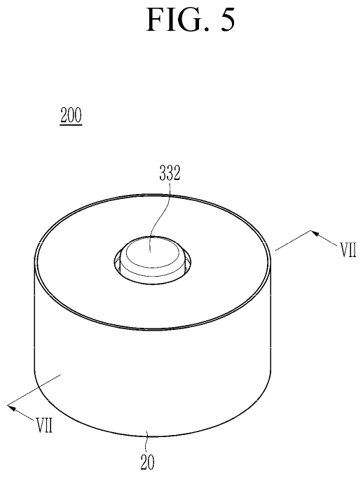

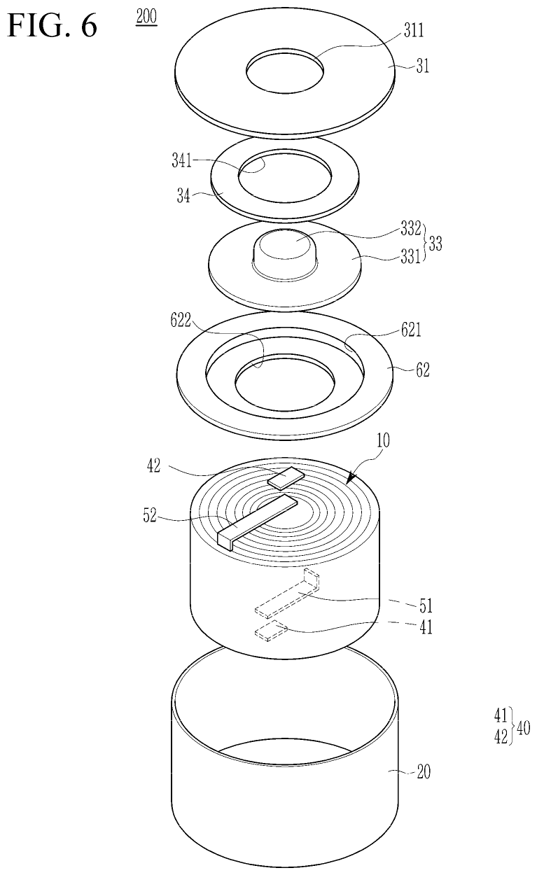

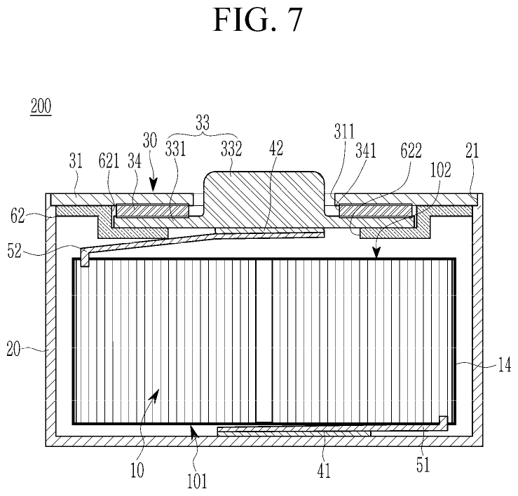

FIG. 5 is a perspective view showing a rechargeable battery according to an embodiment of the present invention; FIG. 6 is an exploded perspective view of the rechargeable battery of FIG. 5; and FIG. 7 is a cross-sectional view taken along the line VII-VII of FIG. 5.

Referring to FIG. 5 to FIG. 7, in a cap assembly 30 of a rechargeable battery 200 according to an embodiment, a terminal plate 33 includes a flange part 331 and a protruded terminal 332. The flange part 331 is disposed between the cap plate 31 and the electrode assembly 10, disposed inside a step 621 of an insulating member 62, and electrically insulated and attached to the inner surface of the cap plate 31 with the thermal fusion member 34 interposed therebetween.

In the terminal plate 33, the protruded terminal 332 is protruded from a center to an outside of the flange part 331 to pass through the through hole 341 of the thermal fusion member 34 and the terminal hole 311 of the cap plate 31, and the second electrode tab 52 is electrically and mechanically connected to an inner surface of the flange part 331 with the second conductive double-sided tape 42 interposed therebetween.

The second connection is electrically and mechanically connected with the second conductive double-sided tape 42 interposed between the upper surface of the second electrode tab 52 and a lower surface of the terminal plate 33 facing each other. That is, the second connection is made with the second conductive double-sided tape 42 interposed between the upper surface of the second electrode tab 52 and a lower surface of the flange part 331 facing each other. The second conductive double-sided tape 42 facilitates the process of the second connection as simple and convenient, and improves (or reduces) deterioration of electrical characteristics due to poor welding.

The insulating member 62 is disposed on the upper side of the second electrode tab 52, is attached to the inner surface of the cap plate 31, and further extends to the inner surface of the flange part 331. The insulating member 62 may form an electrically insulating structure between the cap plate 31 and the second electrode tab 52, between the cap plate 31 and the electrode assembly 10, and between the flange part 331 and the electrode assembly 10.

As an example, the insulating member 62 has the step 621 corresponding to an exterior diameter of the thermal fusion member 34. Therefore, the protruded terminal 332 is protruded outward from the center of the flange part 331 and protruded outward through the through hole 341 of the thermal fusion member 34 and the terminal hole 311 of the cap plate 31. The flange part 331 is electrically and mechanically connected to the second electrode tab 52 with the second conductive double-sided tape 42 on the open inner surface through a through hole 622 of the insulating member 62.

Herein, embodiments simplifying a process of connecting the external tab of the rechargeable battery to a set are described.

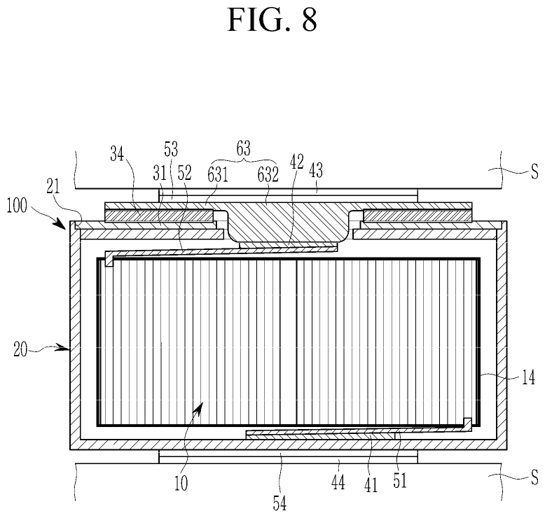

FIG. 8 is a cross-sectional view illustrating electrical connection of an external tab and a set of a rechargeable battery according to an embodiment. Referring to FIG. 8, a third connection and a fourth connection electrically connect a first external tab 53 and a second external tab 54 of the rechargeable battery 100 to a set S, respectively.

The third connection connects the terminal plate 63 to the set S. In an embodiment, a conductive double-sided adhesive member, that is, a third conductive double-sided tape 43 is connected between the first external tab 53 connected to the outer surface of the flange part 631 and the set S.

The fourth connection connects the case 20 to the set S. In an embodiment, a conductive double-sided adhesive member, that is, a fourth conductive double-sided tape 44 is connected between the second external tab 54 connected to the outer surface of the case 20 and the set S.

The third and fourth conductive double-sided tapes 43 and 44 simplify and facilitate a process of the third and fourth connection connecting the first and second external tab 53 and 54 of the rechargeable battery 100 to the set S as convenient, and improve (or reduce) deterioration of the electrical characteristics due to poor welding.

In an embodiment, the third and fourth connections are possible to the extent of supplying the third and fourth conductive double-sided tape 43 and 44 through the feeder and using an attachment jig, such that a simpler facility is required compared to an existing welding facility.

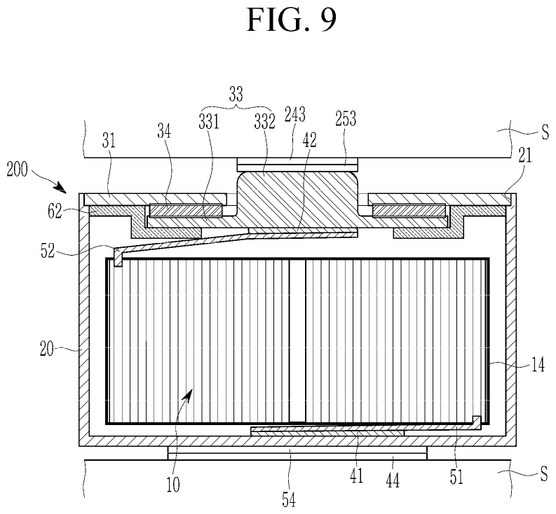

FIG. 9 is a cross-sectional view illustrating electrical connection of an external tab and a set of a rechargeable battery according to an embodiment. Referring to FIG. 9, the third connection connects the terminal plate 33 to the set S. In an embodiment, a conductive double-sided adhesive member, that is, a third conductive double-sided tape 243 is connected between a first external tab 253 connected to an outer surface of the protruded terminal 332 and the set S.

The third conductive double-sided tape 243 facilitates the process of the third connection connecting the first external tab 253 of the rechargeable battery 200 to the set S as simple and convenient, and improves (or reduces) deterioration of electrical characteristics due to poor welding.

While the present invention has been described in connection with what are presently considered to be some practical embodiments, it is to be understood that the invention is not limited to the disclosed embodiments. On the contrary, it is intended to cover various modifications and equivalent arrangements included within the spirit and scope of the appended claims.

What is claimed is:

1. A rechargeable battery comprising:
an electrode assembly comprising a first electrode tab and a second electrode tab;
a case accommodating the electrode assembly and electrically connected to the first electrode tab;
a cap assembly comprising a cap plate coupled to an opening of the case, and a terminal plate coupled to the cap plate in an insulating state and electrically connected to the second electrode tab; and
a conductive double-sided adhesive member applied to at least one of a first connection between the first electrode tab and the case and a second connection between the second electrode tab and the terminal plate.

2. The rechargeable battery of claim 1, wherein the conductive double-sided adhesive member comprises a conductive double-sided tape.

3. The rechargeable battery of claim 2, wherein the conductive double-sided tape comprises:
a conductive mesh part having a mesh structure with conductivity; and
a rubber adhesive filled around the conductive mesh part to form the first connection and the second connection.

4. The rechargeable battery of claim 1, wherein the conductive double-sided adhesive member comprises an anisotropic conductive film.

5. The rechargeable battery of claim 1, wherein the first connection electrically and mechanically connects with a first conductive double-sided tape of the conductive double-sided adhesive member that is arranged between a lower surface of the first electrode tab and an inner surface of the case facing each other.

6. The rechargeable battery of claim 1, wherein the second connection electrically and mechanically connects with a second conductive double-sided tape of the conductive double-sided adhesive member that is arranged between an upper surface of the second electrode tab and a lower surface of the terminal plate facing each other.

7. The rechargeable battery of claim 6, wherein the terminal plate comprises:
a flange part on an outside of the cap plate, and electrically insulated and attached to an outer surface of the cap plate with a thermal fusion member therebetween; and
a tab connection part protruded from a center of the flange part to an inside and protruded toward the electrode assembly through a through hole of the thermal fusion member and a terminal hole of the cap plate, and
the second conductive double-sided tape is electrically and mechanically connected between the second electrode tab and an inner surface of the tab connection part.

8. The rechargeable battery of claim 6, wherein the terminal plate comprises:
a flange part on an inside of the cap plate and electrically insulatedly attached to an inner surface of the cap plate with a thermal fusion member therebetween; and
a protruded terminal protruded from a center of the flange part to an outside and passing through a through hole of the thermal fusion member and a terminal hole of the cap plate, and
the second conductive double-sided tape is mechanically and electrically connected between the second electrode tab and an inner surface of the flange part.

9. The rechargeable battery of claim 1, wherein the terminal plate comprises:
a flange part on an outside of the cap plate, and electrically insulated and attached to an outer surface of the cap plate with a thermal fusion member therebetween; and
a tab connection part protruded from a center of the flange part to an inside of the flange part and protruded toward the electrode assembly through a through hole of the thermal fusion member and a terminal hole of the cap plate, and
in a third connection connecting the terminal plate to a set, a conductive double-sided adhesive member of the third connection is connected between a first external tab connected to an outer surface of the flange part and the set.

10. The rechargeable battery of claim 9, wherein, in a fourth connection that connects the case to the set, a conductive double-sided adhesive member of the fourth connection is connected between a second external tab connected to an outer surface of the case and the set.

11. The rechargeable battery of claim 1, wherein the terminal plate comprises:
a flange part on an inside of the cap plate and electrically insulated and attached to an inner surface of the cap plate with a thermal fusion member therebetween; and
a protruded terminal protruded from a center of the flange part to an outside and passing through a through hole of the thermal fusion member and a terminal hole of the cap plate, and
in a third connection connecting the terminal plate to a set, a conductive double-sided adhesive member of the third connection is connected between a first external tab connected to an outer surface of the protruded terminal and the set.
